(19) United States
(12) Patent Application Publication
(10) Pub. No.: US 2024/0261601 A1
(43) Pub. Date: Aug. 8, 2024

(54) BLOCKING/BRAKING DEVICE FOR ADJUSTING A SAFETY ROPE

(71) Applicant: ALUDESIGN S.P.A., Lecco (LC) (IT)

(72) Inventors: Giovanni GARELLO, Lecco (LC) (IT); Carlo LOSA, Lecco (LC) (IT); Davide GALLETTI, Lecco (LC) (IT)

(21) Appl. No.: 18/566,153

(22) PCT Filed: Jun. 6, 2022
(86) PCT No.: PCT/IB2022/055244

§ 371 Date: Dec. 1, 2023

(30) Foreign Application Priority Data
Jun. 4, 2021 (IT) 102021000014612

(51) Int. Cl. A62B 1/14; F16D 63/00

(52) U.S. Cl. CPC A62B 1/14; F16D 63/008

(57) ABSTRACT

Blocking/braking device (1) for adjusting a safety rope (2), comprising an at least partially hollow body (10) provided with a path (12) for the passage inside said body (10) of said safety rope (2); said body (10) comprising a main portion (11), a first portion (13) and a second portion (14) defining between them a concavity (15), and said path (12) comprising a first length (121) extending in said first portion (13) and comprising a first seat (12a), and at least one second length (122) extending at least in said second portion (14) and comprising a second seat (12b); said concavity (15) being, in use, configured to be crossed by said safety rope (2), said body (10) defining a closed section (16) with said safety rope (2) inside said concavity (15).

### FIELD OF THE INVENTION

The present invention relates to a blocking/braking device for adjusting a safety rope. In particular, the present invention concerns a blocking/braking/adjusting device of a safety rope, adapted to be used for securing/positioning a load to an anchoring point, whether it is an object or a person, e.g. during an ascent or descent along a wall or in work at height.

The present invention is mainly used in the field of sport climbing equipment, but also for professional use in works at height.

In these fields, the need to secure and position loads or persons at suitable anchoring points by means of a rope is indeed common.

It should be immediately noted that in the present document reference will be made to the blocking and/or braking and/or adjustment of the safety rope, meaning that the device of the invention can determine the blocking of the rope, the braking of the rope, the adjustment in position at a suitable distance from the anchorage by means of the device that acts on said rope, or also the combination of braking/adjustment of the rope which then leads to the blocking of the same rope.

### Known Prior Art

Devices configured to block and/or brake a safety rope or cord are known in the art, e.g. to lock a load during an ascent or descent (also called rappel), for example, along a wall. Said load, depending on the situations, can be a person or an object.

Variants of these devices are dedicated to the adjustment and positioning at a suitable distance from an anchoring point by means of their action on said rope.

In the present document, the terms “adjustment” and “positioning” mean the sliding of the safety rope inside the blocking/braking device for controlling the length of the loaded length of the rope. In particular, it is understood as the sliding of the safety rope inside the blocking/braking device for the control of the length of the rope length between the anchoring point and the load to be secured.

Furthermore, it is noted that the terms “blocking/braking device for adjusting a rope” and “blocking/braking/adjusting device of a rope” are synonymous with each other and will be used interchangeably in the following description without different terms denoting different entities.

Said blocking/braking devices for adjusting a rope are typically used in climbing sports, both outdoors and indoors, in order to secure and position, during some operations of climbing and descending a wall, e.g. at a belay or stop, one or more climbers, thus avoiding their free fall by restraining/blocking the rope to which the climber or climbers are secured.

Furthermore, said blocking/braking/adjusting devices are used during work at height, both to ensure operators who work at various metres in height and to streamline the management of rope manoeuvres.

In their most basic form, said blocking/braking/adjusting devices consist of a partially hollow main body inside which the aforesaid rope is housed, with a loaded branch constrained to the object to be secured and a free branch. Said devices are then combined by means of connectors, typically a karabiner, to anchoring points or an operator. Devices are known that work by exploiting the friction between the safety rope and the body parts of the device. For example, in some known devices, when the loaded branch of the rope is subjected to tension, the friction exerted acts on the device, e.g. by rotating it and causing a geometric configuration or positioning thereof, with respect to the connector to which it is connected, which leads to a substantially immediate blocking. On the contrary, by returning the device to a geometric configuration for loosening and releasing the rope, e.g. by rotating it, it is possible to release the load more or less gradually.

Known examples of specific blocking/braking/adjusting devices in the field of sport climbing and rope access work consist of the so-called positioning adjusting devices. Among the aforesaid devices, the category of simplified mechanical devices is of particular interest, in which the actuation of the device, i.e. its switching between the braking/blocking configuration and the adjusting configuration by means of free sliding of the rope, is determined by a movement of the same device, e.g. a rotation. An example belonging to the above-mentioned category of mechanical blocking/braking devices is set forth in document EP 2666518 A2.

These devices are typically equipped with a hole, inside which a connector, e.g. a karabiner, is inserted, while the safety rope is inserted into the device so as to interfere at least partially with the aforesaid hole. In a proper use of these devices, e.g. with reference to the figures of document EP 2666518 A2, the connector is inserted into the hole so that it is crossed by the safety rope, i.e. the safety rope must pass through the closed section of the connector. The blocking/braking/adjusting device is shaped so that the walls defining the hole have two different profiles: one in which the contact between the rope and the connector is not possible, the other in which the connector can contact the rope until pushing it against an abutment wall. In the free-sliding configuration, there is essentially no interaction between the connector and the safety rope, with the latter therefore being free to slide inside the device. In the blocking/braking configuration, the connector contacts the safety rope, which is pushed towards the aforesaid abutment surface. The action of the connector generates friction between the rope and the abutment wall, thus braking the sliding of the rope. Generally, the switching between the above-mentioned blocking/braking and free-sliding/adjusting positions is caused by a relative rotation between the device and the connector, caused by the same friction force. Typically, the abutment wall has a profile such as to ensure the throttling of the rope between the connector and the same wall when the device is in the blocking/braking configuration. For example, the abutment wall may be equipped with a recess or groove, inside which the safety rope is pushed by the connector so that the rope assumes such a shape that blocks its sliding as long as the connector holds it in position in this recess. Preferably, intermediate configurations between the free-sliding and blocking configurations allow the generation of a friction such that obstructed or controlled, i.e. braked, sliding of the safety rope is ensured.

Although particularly appreciated for their simplicity of construction and use, said devices have certain drawbacks that can compromise the safety of the secured load and thus constitute an element of risk for persons as well.

As previously described, in these devices the connector must be inserted inside the hole, paying particular attention to the fact that the safety rope crosses the closed section of the same connector. In fact, if the connector is inserted inside the hole of the device without being crossed by the safety rope, i.e. outside the rope, the blocking/braking/adjusting device would not be able to fulfil its function even following a rotation thereof. Not being crossed by the safety rope, the connector could not interact with it, thus pushing it against the abutment wall defining the aforesaid hole, to brake and possibly block it.

Another limitation of known blocking/braking devices is determined by the possible faulty engagement of the connector, which prevents the proper movement of the connector inside the device's hole. This drawback can also be caused by the use of elements that are accessory to the connector, e.g. swivel nuts or rubber karabiner-retaining rings, or by unwanted rotations of the same connector. A faulty engagement can affect the proper functioning of the device, which may not be able to block, or even brake, the safety rope, thus resulting in risks to the safety of the secured load.

Still another drawback of the known blocking/braking devices is their dependence on the dimensions (and in particular the diameter) or shape of the connector section, also in relation to the dimension of the safety rope used. Connectors and safety ropes that are shaped differently and/or have different sections result in different behaviours of the blocking/braking/adjusting device. A different behaviour can lead to premature or delayed, and in any case undesirable, blocking of the safety rope. Consequently, the manufacturers of known devices require the end user to use only connectors and ropes declared compatible, thus preventing free use of the connectors and/or ropes by the same end user, who is forced to perform compatibility tests in order to adopt the solutions of his/her preference.

It is therefore an object of the present invention to solve the aforementioned drawbacks of the known art and to provide a reliable device for blocking/braking/adjusting a safety rope, which is easy to use and does not have any risk linked to incorrect installation of the connector.

It is a further object of the present invention to provide a device for blocking/braking/adjusting a safety rope, which does not have any problems linked to possible faulty engagement of the connector.

Still another object of the present invention is to provide a device for blocking/braking/adjusting a safety rope that is compatible with almost all safety ropes and connectors on the market, or that functions almost independently of the type or dimensions of the connector or rope used.

### SUMMARY OF THE INVENTION

These and further objects are achieved by the present invention by means of a blocking/braking device for adjusting a safety rope according to claim 1, a blocking/braking system for adjusting a safety rope according to claim 16 and a method for adjusting a safety rope and positioning a load according to claim 22. Further preferential features and aspects of the invention are stated in the dependent claims.

It should be noted from the outset that aspects and/or features described and/or claimed herein, with reference to the device, can be applied to the system (or method), and vice versa. According to a first aspect, the present invention relates to a blocking/braking device for adjusting a safety rope, hereinafter also referred to as a blocking/braking/adjusting device for the sake of simplicity.

As stated, in this document the terms “adjustment/adjusting” and “positioning” mean the sliding of the safety rope inside the blocking/braking/adjusting device for the control of the length of the rope length interposed between the anchoring point and the load to be secured.

Said blocking/braking/adjusting device comprises an at least partially hollow body provided with a path for the passage of a safety rope. Specifically, said path is defined between a first seat, which is adapted to accommodate a free branch of said safety rope, and a second seat, which is adapted to accommodate a loaded branch of said safety rope. The cavity with which the body of the blocking/braking/adjusting device is equipped defines the path inside which the safety rope is slidably housed, i.e. the rope can slide along the path inside the blocking/braking device.

In the present description, the term “loaded branch” refers to the length of the safety rope adapted to be constrained to a load or to an anchoring point (in the possible mode of use where it is the device that is constrained to a load or a person). Thus, the loaded branch is the length of the safety rope adapted to be subjected to tensioning due to the weight force of the load, e.g. positioned at one end of the rope, which is intended to be secured and/or positioned at a desired distance from an anchoring point to which the device will be connected by means of a connector. For example, in the case where the device is used to secure/position a climber, the loaded branch of the rope corresponds to the portion of rope interposed between the anchoring point (to which in this case the device is constrained) and the climber. Similarly, in the case where the load to be secured is an object, the loaded branch corresponds to the portion of rope interposed between the anchoring point (to which in this case the device is constrained) and the object, which is firmly combined with the rope, and therefore through the device and the relative connector, with the anchorage.

It is assumed herein that, as a rule, such devices are connected to an anchoring point by means of a connector, with the loaded branch of the rope connected to the person or load to be secured, e.g. by means of a knot or a connector. As mentioned, of course, inverted use, in which the device is connected to the load or person and the loaded branch of the rope is connected to an anchoring point, e.g. by means of a knot or a connector, is to be considered equivalent. In other words, the functionality and use of the device as described are to be understood as operating indifferently with the device connected to an anchoring point and with the device connected to the load or person to be secured.

In these cases, the loaded branch of the rope corresponds to the portion of rope interposed between the anchoring point and the climber (or the load) to which, as stated, in this case the device is connected.

On the contrary, the term “free branch” means the remaining portion of rope that extends from the blocking/braking/adjusting device to the other end of the safety rope and which is typically left free, i.e. not constrained to any object that causes it to be tensioned. For example, such a free branch can be manoeuvred, e.g. tensioned, by an operator to shorten the distance between him/herself and the anchorage to which the device will be connected through a connecting element, e.g. a karabiner.

The body of the main device has a mainly two-dimensional or flat development, i.e. it extends mainly along two dimensions, while the third dimension, typically called thickness, is shorter than the other two dimensions.

Said body is preferably made of metal material, even more preferably of metal material with high mechanical features and low weight, e.g. steel, aluminium or equivalent materials/alloys.

According to an aspect, the body of the blocking/braking/adjusting device comprises a main portion, a first portion and a second portion defining a concavity between them. In other words, the body of the blocking/braking/adjusting device has, along the main development plane, a concave section or portion defined by the first portion and the second portion together with the main portion.

According to an aspect, the first portion and the second portion are defined as two portions protruding or jutted from the main portion. Said first and second portions are defined as two protuberances branching off from the main portion of the body of the blocking/braking/adjusting device so as to define the aforesaid concavity or concave portion between them. Said concavity is, therefore, defined as a loop or depression that breaks the profile of the body of the blocking/braking device.

According to an aspect, the path defined inside the body of the blocking/braking/adjusting device comprises a first length and at least one second length.

Said first length extends in said first portion and comprises said first seat, i.e. said first portion is at least partially hollow to define said first length extending from said first seat. In particular, said first length extends in said first portion from said first seat to a first opening facing said concavity.

Said at least one second length extends at least in said second portion and comprises said second seat. Preferably, said at least one second length extends from said second portion, where there is a second opening which faces said concavity, to said main portion where said second seat is arranged. Said at least one second length may comprise one or more second lengths, i.e. it may consist of a single continuous second length or more discontinuous but communicating second lengths.

Said concavity, in use, is configured to be crossed by said safety rope, i.e. the safety rope divides or cuts said concavity. Specifically, the body of the blocking/braking/adjusting device defines a closed section with said safety rope inside said concavity. This closed section is configured, in use, to accommodate a connector, which is then crossed by said safety rope.

In the present document, the term “connector” means any anchoring element having a ring-like or otherwise closed profile (preferably having a movable portion, or length, for the temporary opening of the closed section, e.g. for the insertion of the rope), which profile is adapted to be crossed by a safety rope and to be combined with said blocking/braking/adjusting device in said closed section. Typical examples of connectors are karabiners and anchoring rings, whatever their dimension or shape is.

As will be better described later in the present description, once the connector has been inserted into the closed section defined by the body of the device and the safety rope, it will be possible to use the blocking/braking/adjusting device to block or brake said safety rope. A reciprocal rotation between the blocking/braking/adjusting device and the connector, caused by the tensioning of the loaded branch of the rope, will allow the switching between a free-sliding position, in which the rope is free to slide inside the path in the body of the blocking/braking/adjusting device with a sliding direction from the second portion to the first portion, and a blocking/braking position when the rope is drawn back with a direction from the first portion to the second portion, in which the sliding of the same rope is obstructed or prevented due to the interaction between the connector and the rope.

Advantageously, the blocking/braking/adjusting device, once the safety rope has been inserted therein, allows to avoid faulty installations of the connector. In fact, it is almost impossible for the connector to be inserted outside the rope, i.e. without the closed profile of the connector being crossed by the safety rope. Once inserted into the closed section, the connector is implicitly (consequently) crossed by the safety rope. As a result, the reciprocal rotation between the blocking/braking/adjusting device and connector causes a movement of the connector inside the closed section of the concavity and thus an interaction which, as will be better seen below, can be of a direct or indirect type (e.g. by means of the presence of a movable insert) between connector and safety rope.

Still advantageously, as will be seen in more detail below, the blocking/braking/adjusting device according to the present invention can be used with any type of connector (and/or safety rope), provided that it is of dimensions appropriate to be inserted into said closed section (and/or into said seats of the device body). This allows the end user to use the blocking/braking/adjusting device with ropes and/or connector of his/her preference, without necessarily having to equip him/herself with compatible components.

Preferably, as will become clearer below in the present description with reference to the accompanying figures, said concavity extends substantially along a first axis (e.g. the axis will be shown below in a possible embodiment of FIG. 4D). Even more preferably, said first and second portions have a development axis substantially parallel to the first development axis of the concavity, i.e. they branch off from said main portion substantially parallel to the first axis. In this embodiment, the body of the blocking/braking/adjusting device has a substantially “U” shape in one section thereof along the main development plane. The present document will illustrate a concavity with a mainly linear development.

However, more complex embodiments, having curvilinear lengths or multiple rectilinear lengths angled to each other, are nevertheless to be considered valid and comprised in the object of the present invention. In particular, the concavity may have a development line comprising at least one curvilinear length or at least two rectilinear lengths angled to each other or a combination of at least one curvilinear length and at least one rectilinear length. In these embodiments, the first and second portions of the body of the blocking/braking/adjusting device also have contours that reproduce this development line or extend similarly to the same development line, so as to delimit such concavity.

Still preferably, said first length of the path extends, in said first portion, in one end thereof distal to the main portion of the body. Similarly, said at least one second length extends, at least as far as the branch involving the second portion is concerned, in an end distal to the main portion of the body. Advantageously, this way, the closed section of the concavity is particularly wide and prevents any faulty engagements of the connector caused by the use of accessory elements, e.g. rubber swivel nuts or connector holders, which will not be described in detail as they are known in the technique, or by unwanted rotations of the same connector.

Preferably, as e.g. will be seen in more detail with exemplary reference to FIG. 4E, the first length of the path is substantially rectilinear, i.e. said first length extends substantially in a straight line from said first seat to said first opening facing the concavity. Still preferably, said at least one second length comprises at least one rectilinear sector extending at said second portion, i.e. said at least one second length comprises a rectilinear sector which extends substantially in a straight line from said second opening facing the concavity. The at least one second length comprises at least one curvilinear sector to join said rectilinear sector with the second seat arranged at the main portion of the body. Advantageously, the linear shape of the path or a length thereof allows a smoother sliding of the safety rope. As stated, these path lengths are depicted by way of example in FIG. 4E, which will be described in detail below.

According to a preferred embodiment, said first length of said path extends along a second axis and said rectilinear sector of said at least one second length of the path extends coaxially to said first length, i.e. said first length and said rectilinear sector are aligned.

According to another embodiment, said first length and said rectilinear sector are angled to each other, i.e. they are arranged to form an angle with each other. Preferably, said angle is between 140° and 180°. Even more preferably, said angle is between 150° and 170°, such as e.g. depicted in more detail below with reference to FIG. 4F. According to an aspect, said second development axis of the first length is not parallel to said first development axis or line of said concavity. Preferably, said first axis and second axis form an angle with each other between 60° and 120°. Even more preferably, said first axis or development line and said second axis form an angle with each other between 75° and 105°. According to an embodiment, said first and said second axes, or said development line and said second axis, are substantially perpendicular to each other. Thus, the safety rope crosses the concavity perpendicularly to the first axis or development line of the same concavity. This way, the blocking/braking action of the connector, once inserted inside the closed section of the concavity, is more effective. In fact, once inserted inside the concavity, the connector can slide along the first axis inside the concavity to interact with the safety rope, thus increasing the friction force and eventually throttling it between said first and second lengths of the path. Said action is more effective if the force exerted by the connector acts perpendicular to the safety rope.

According to another aspect, the blocking/braking/adjusting device comprises a movable insert. In particular, the movable insert is configured to be movably housed inside said concavity and to be interposed, in use, between said safety rope and said connector. Specifically, said movable insert is configured to cooperate with said connector during the blocking or braking actions of the safety rope. Preferably, the movable insert can be moved inside the concavity along a direction defined by the first development axis of the same concavity. Said movable insert, therefore, avoids the direct contact between the connector and the safety rope and acts on the safety rope under the action of the connector. Advantageously, the presence of the movable insert allows to operate effectively and homogeneously on the safety rope, thus ensuring optimal blocking or braking action regardless of the geometric and dimensional shape of the connector used.

Said movable insert is preferably made of metal material, even more preferably of metal material with high mechanical features and low weight, e.g. steel, aluminium or equivalent materials/alloys.

According to an embodiment, said movable insert comprises an at least partially tubular first element. Said first movable element of the insert has a housing configured, in use, to contact said safety rope. In other words, said housing is configured to accommodate and contact said safety rope. According to an embodiment, said housing is a concave housing. According to another embodiment, said first element has a hollow tubular or ring-like shape, in which the inner cavity is the aforesaid housing, inside which the safety rope is passed. Advantageously, the presence of the first element with a housing adapted to accommodate the rope ensures an optimal contacting surface with the safety rope, preferably mirrored to the safety rope, and an optimal action on the safety rope during the blocking or braking actions.

According to an embodiment, the movable insert has a second flat element adapted, in use, to be arranged to partially obstruct said closed section. In particular, said second element is equipped with a hole. Said hole, therefore, exposes at least one part of the closed section and is configured, in use, to accommodate, i.e. to be crossed by said connector. Advantageously, the presence of the second element equipped with a hole allows a more immediate and convenient insertion of the connector inside the closed section and a more effective action on the safety rope in the blocking and braking actions.

According to a preferred aspect, said second element comprises a slot. The slot is configured to allow the combination, preferably by means of a pin or similar constraining element, between said insert and said body. In other words the pin, by passing through the slot and being constrained to the body of the blocking/braking device, allows said removable insert to be movably connected to said body of the blocking/braking/adjusting device. Specifically, said slot has a longitudinal development which limits the movement of the removable insert inside the concavity of the body of the braking/blocking device. In other words, the slot acts as an end-stop for the movement of the removable insert inside the concavity and defines its direction of movement so that the removable insert can only make movements useful for the purposes of interacting with the safety rope.

According to a further aspect not shown, the blocking/braking/adjusting device comprises a lever. Said lever is configured to allow the end user to grip it in the rotation operations of said device. Preferably, said lever is constrained (or made in one piece) to the body of the braking/blocking device. Advantageously, the presence of the lever makes the rotation operations easier, and therefore the loosening of the applied load and respective adjustment of the length of the loaded branch of the rope, of the blocking/braking/adjusting device when it is used in combination with the connector to brake or block the sliding of the safety rope and, therefore, in order to suitably adjust the length of the loaded branch of the rope.

A safety blocking/braking/adjusting system comprising the blocking/braking/adjusting device described and/or claimed herein is also object of the present description. As specified above with regard to the device, in the following description, the terms “blocking/braking system for adjusting a rope” and “blocking/braking/adjusting system of a rope” are synonymous with each other and will be used interchangeably without different terms denoting different entities.

The blocking/braking/adjusting system further comprises a safety rope. Said safety rope has a free branch and a loaded branch, the latter being adapted to be firmly combined with a load to be secured, possibly by interposing the device according to possible embodiments in which the load (or a person) is connected to the device and the loaded length of rope is constrained to an anchoring point. Said safety rope is configured to be housed in said blocking/braking/adjusting device with the free branch in said first seat of the path defined in the body of the aforesaid device and with the branch loaded in said second seat. In particular, said safety rope, when travelling along the path in said body of the blocking/braking device, is configured to cross said concavity, thus defining a closed section with said body of the braking/blocking device.

Starting from said first seat and arriving at the second seat, the safety rope travels along the first length of the path, exits from the first opening facing the concavity, enters the second opening facing the concavity, de facto crossing the concavity and defining the aforesaid closed section, before travelling along the at least one second length of the path until the second seat is reached.

The blocking/braking/adjusting system also comprises a connector. Said connector is configured to be inserted into said closed section and to be crossed by said safety rope. In use, therefore, the connector has at least one part of its closed profile interposed between the body of the blocking/braking/adjusting device and the safety rope.

Preferably, the blocking/braking/adjusting system is configured to be movable between a free-sliding position and a blocking/braking position. In the free-sliding position the safety rope is free to slide, from the second portion towards the first portion, inside the path of said blocking/braking device. In this position, the connector mainly contacts the body of the blocking/braking/adjusting device, typically at its second portion. In the blocking/braking position, on the other hand, the sliding of the safety rope in said path, from the first portion towards the second portion, is prevented or braked. Specifically, the sliding of the rope is prevented by the action of the connector which, directly or indirectly by means of a movable insert, pushes on said safety rope, which in turn contacts the body of the blocking/braking/adjusting device and, due to the friction generated, cannot slide freely inside the aforesaid path. The action of the connector may be such as to throttle the rope (thereby generating friction), thus totally blocking its movement (blocking condition), or only to slow its sliding due to the friction generated by the contact on the walls of the body of the blocking/braking/adjusting device (braking condition).

The switching between said free-sliding position and said blocking/braking position is determined by a relative rotation between the braking/blocking/adjusting device and the connector. Switching from the free-sliding position to the blocking/braking position corresponds to a relative rotation between braking/blocking/adjusting device and connector in one direction (clockwise or counter-clockwise depending on perspective). The opposite switching from the blocking/braking position to the free-sliding position is determined by a corresponding relative rotation between braking/blocking/adjusting device and connector in the opposite direction. During this rotation, the friction gradually decreases its braking/blocking action and the length of the loaded branch of the rope can therefore be adjusted in order to perform precise positioning.

The blocking/braking/adjusting system therefore allows an easy and safe installation, without exposing the end user to the risk of incorrect insertions or faulty engagements of the connector, regardless of the safety rope used and the dimensions or shape of the same connector.

According to an embodiment of the blocking/braking system, the connector mainly contacts the body of the blocking/braking/adjusting device when the system is in said free-sliding position. When, on the contrary, the system is in said blocking/braking position, the connector contacts said safety rope, which under the action of the connector in turn contacts the body of the device and is braked. Specifically, in the blocking/braking position, the rope is forced onto the walls of the first and second portions at the first length of the path and the at least one second length of the path.

According to another embodiment of the blocking/braking/adjusting system, the use of said movable insert is provided. In such an embodiment, the connector acts indirectly, by stressing said insert, on said safety rope when the blocking/braking/adjusting system is in blocking/braking position. As previously mentioned, the interposition of the insert, which has a housing for optimally contacting the safety rope, allows to act effectively on the rope regardless of the shape of the connector.

In the embodiments in which the blocking/braking/adjusting device has a movable insert having a second element equipped with a hole, the connector is passing through said hole. The presence of the hole ensures ease of insertion of the connector and continuity of contact of the connector, during the rotation, with the device. Preferably, the hole has a circular section which therefore ensures gradual switching from the free-sliding position to the blocking position, thus allowing gradual braking of the rope before it becomes locked. This ensures a more gradual handling of the secured load and a more comfort of use of the system.

Still another object of the present description is a method for adjusting a safety rope and positioning a load by using the blocking/braking/adjusting device described and/or claimed herein, and/or by using the blocking/braking/adjusting system described and/or claimed herein.

The method comprises the following steps of:
inserting the safety rope into said blocking/braking device;
inserting said connector into said closed section;
securing a load to said safety rope or to said blocking/braking device;
adjusting the length of said safety rope to position said load.

The step of inserting the rope provides that the safety rope is inserted into said first seat of the path, subsequently passing through said first length and through said at least one second length and then exiting from said second seat. The safety rope has the free branch entering said first seat and the loaded branch exiting from said second seat. In particular, passing from said first length to said at least one second length of said path, the safety rope creates, inside the concavity of the device, a closed section with said body.

The next step of inserting said connector into said closed section provides that said connector is crossed by said safety rope.

It should be noted that the step of inserting the connector can be carried out directly during the manufacturing of the device and, therefore, the end user can be equipped with the safety rope already inserted into the device. In general, it should be noted that the steps described and/or claimed herein are not to be understood as necessarily carried out by the user, but they may be carried out during the manufacturing of the device directly by the manufacturer.

In addition, according to possible embodiments, the step of inserting said safety rope can also be carried out after the step of inserting the connector. In such configuration, the connector is housed inside the concavity of the blocking/braking/adjusting device and, subsequently, the rope is inserted into the same device by crossing the connector.

Subsequently, the step of securing a load to said safety rope or said blocking/braking device provides for firmly combining or constraining, typically by means of a knot or a slot and possibly an additional connector, the aforesaid load, e.g. a person or an object, to the loaded branch of said safety rope (or to the device according to possible embodiments in which the load is connected to the device and the loaded length of rope is constrained to an anchoring point).

Finally, the step of adjusting the length of said safety rope to position said load provides for modifying the relative position between said blocking/braking/adjusting device and said connector. In other words, the step of adjusting the length of said rope to position said load provides for modifying the length of the loaded branch of the safety rope, i.e. the distance between the load and the relative anchoring element to which the load is secured.

In the case of possible use with the device constrained to an anchoring point and the load constrained to the loaded length of rope, the step of adjusting the length of the rope provides for modifying the length of the loaded branch of the safety rope, i.e. the distance between the load and the anchoring point to which the device is constrained, by sliding the safety rope inside the blocking/braking device for the control of the length of the segment of rope between the anchoring point (to which the device is constrained) and the load to be secured.

In the case of a possible use in which the load is connected to the device and the loaded length of rope is constrained to an anchoring point, the step of adjusting the length of the rope provides for modifying the length of the loaded branch of the safety rope, i.e. the distance between the load (to which the device is constrained) and the anchoring point through the sliding of the safety rope inside the blocking/braking device for the control of the length of the segment of rope between the anchoring point and the load to be secured (to which the device is constrained).

According to an aspect, the relative position between said blocking/braking/adjusting device and said connector may be any position between a free-sliding position, in which the safety rope is free to slide inside the path of said blocking/braking/adjusting device, and a blocking/braking position, in which a sliding of the safety rope along said path is prevented or braked. This adjustment in length of the loaded branch of the rope is known in the reference sector with the term “positioning”. It should be noted that the blocking/braking/adjusting device and connector may also assume intermediate relative positions between the free-sliding positions and the blocking/braking positions, in order to allow the rope to slide a controlled and gradual manner. In particular, when said loaded branch is subjected to tension due to the weight of the secured load, the blocking/braking/adjusting system is brought to the blocking/braking position. The blocking/braking/adjusting system can be brought by rotating it, typically manually by an operator, to the free sliding position, e.g. when the loaded branch is not subjected to tensioning, due to the application of a traction force on the free branch or because the load unloads its weight force on a support or rest.

It should be noted that by manually acting on the blocking/braking device, an operator can generate a controlled sliding of the safety rope. Specifically, an operator can only partially rotate the blocking/braking/adjusting device without making it assume the free-sliding position with respect to the connector. In this condition, the safety rope is not throttled against the walls of the body and allows a controlled, i.e. braked but not blocked, movement of the secured load. The operator can use the lever, with which the blocking/braking/adjusting device is preferably equipped, to facilitate the manoeuvre. Advantageously, in this configuration, it is possible to control the speed of releasing the load and thus the respective branch length and the positioning of the load and the position.

Advantageously, the operator can also act by stressing the free branch of the rope by traction while manually rotating the device.

Preferably, prior to the step of inserting said safety rope, the method comprises a step of movably housing said movable insert inside said concavity.

In the embodiments in which the blocking/braking/adjusting device comprises a movable insert equipped with a second element with a hole, the step of inserting said connector provides for inserting said connector through said hole.

### BRIEF DESCRIPTION OF THE FIGURES

Further aspects and advantages of the present invention will become clearer from the following description, given by way of example with reference to the accompanying schematic drawings, wherein:

FIGS. 1A-1C depict three views (1A perspective view, 1B front view and 1C side view) of a first embodiment of the blocking/braking device for adjusting a safety rope, also referred to as a blocking/braking/adjusting device, according to the invention;

FIGS. 2A-2C depict three views (2A perspective view, 2B front view and 2C side view) of a second embodiment of the blocking/braking/adjusting device according to the invention;

FIGS. 3A-3C depict three views (3A perspective view, 3B front view and 3C side view) of a third embodiment of the blocking/braking/adjusting device according to the invention;

FIGS. 4A-4D depict four views (4A perspective view, 4B front view, 4C side view and 4D sectional view according to the section plane B-B) of a further embodiment of the blocking/braking/adjusting device according to the invention;

FIGS. 4E and 4F depict two configurations of the path of the safety rope in the blocking/braking/adjusting device of FIG. 4A, which has been suitably shaped to determine these two configurations;

FIG. 4G depicts another embodiment of the blocking/braking/adjusting device according to the invention;

FIGS. 5A and 5B depict, respectively, a front view and a sectional view of the blocking/braking/adjusting system according to the present invention comprising the blocking/braking/adjusting device of FIG. 4A, and of the rope in a first substantially braked/blocked configuration, and therefore in a first non-sliding configuration;

FIGS. 6A and 6B depict, respectively, a front view and a sectional view of the blocking/braking/adjusting system of FIGS. 6A-6B in a second, substantially free rope-sliding configuration;

FIGS. 7A and 7B depict, according to two perspective views, the blocking/braking/adjusting device in FIG. 4A in accordance with a different embodiment;

FIGS. 8A and 8B depict, respectively, a front view and a sectional view of the blocking/braking/adjusting system according to the present invention comprising the device of FIGS. 7A-7B, and of the rope in a first substantially braked/blocked configuration, and therefore in a first non-sliding configuration;

FIGS. 9A and 9B depict, respectively, a front view and a sectional view of the blocking/braking/adjusting system of FIGS. 8A-8B in a second, substantially free rope-sliding configuration;

FIGS. 10A and 10B depict, according to two perspective views, the blocking/braking/adjusting device in FIG. 4A according to a further embodiment;

FIGS. 11A and 11B depict, respectively, a front view and a sectional view of the blocking/braking/adjusting system according to the present invention comprising the device of FIG. 10A, and of the rope in a first substantially braked/blocked configuration, and therefore in a first non-sliding configuration;

FIGS. 12A and 12B depict, respectively, a front view and a sectional view of the blocking/braking/adjusting system of FIGS. 11A-11B in a second, substantially free rope-sliding configuration;

FIGS. 13A-13E depict five views (perspective view 13A, front view 13B, side view 13C, sectional view 13D and exploded view 13E) of a further embodiment of the blocking/braking/adjusting device according to the present invention;

FIG. 14 shows a possible embodiment of the safety rope that can be used in the device according to the present invention.

### DESCRIPTION OF SOME EMBODIMENTS

With reference to the accompanying figures, a blocking/braking device for adjusting a safety rope 2 in various embodiments according to the present invention, has been denoted by reference 1 and will hereinafter be referred to as device 1 for the sake of simplicity. It should be immediately noted that in the accompanying figures, similar elements of the various embodiments will be denoted by the same reference numerals.

The device 1 comprises an at least partially hollow body 10. Said body 10 is preferably made of metal material, even more preferably of metal material with high mechanical features and low weight, e.g. steel, aluminium or equivalent materials/alloys.

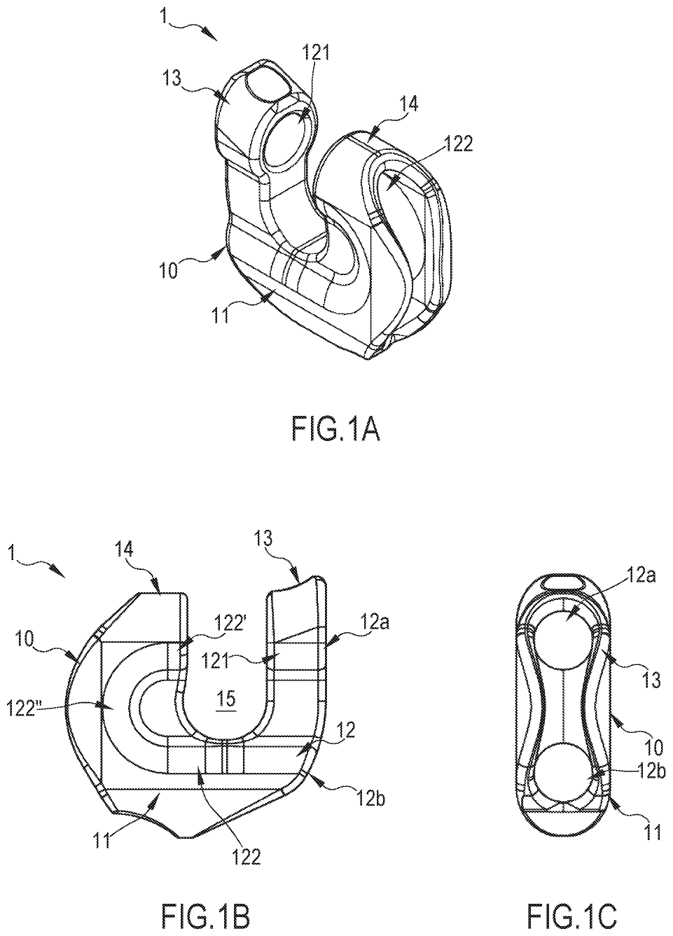

FIGS. 1A-1C, 2A-2C and 3A-3C depict three different embodiments of the body 10 of device 1, which differ in the technique used for their creation.

FIGS. 1A-1C show an embodiment in which the body 10 is made by deep-drawing and/or bending a metal sheet in order to make a hollow body.

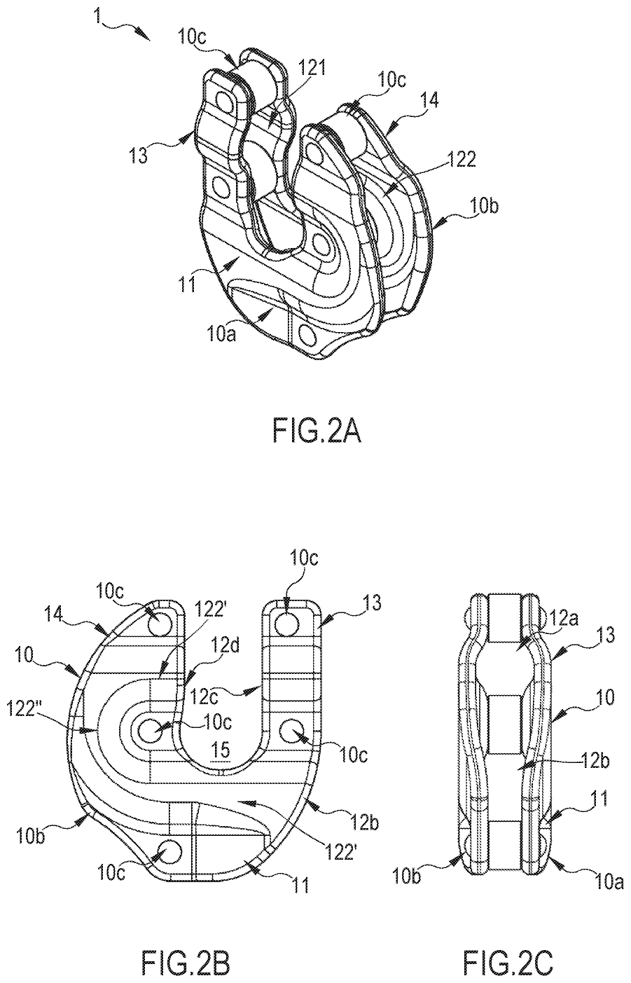

FIGS. 2A-2C depict a different embodiment, wherein the body 10 consists of two plates 10a and 10b parallel and constrained to each other by a plurality of pins or rivets 10c. For example, in the depicted embodiment, five pins, or rivets 10c, are used.

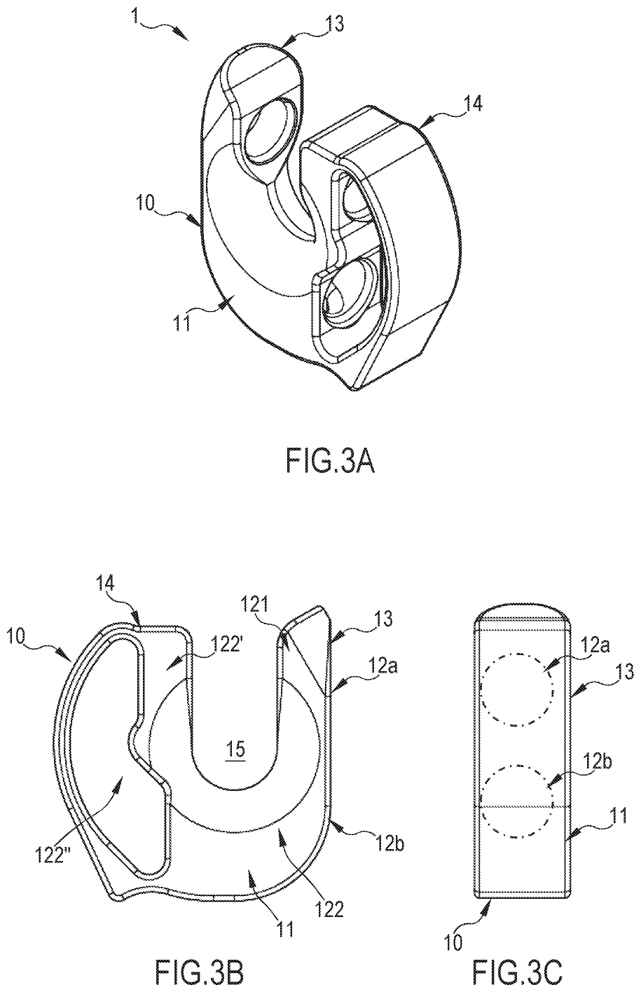

FIGS. 3A-3C depict yet another embodiment in which the body 10 is extruded and/or forged and/or machined to provide its final shape.

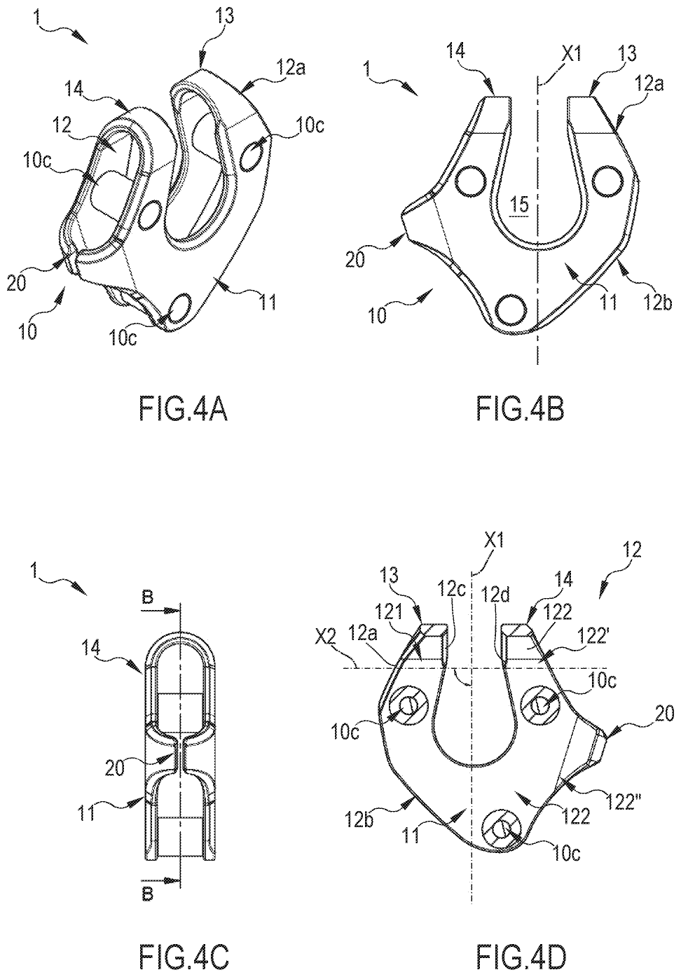

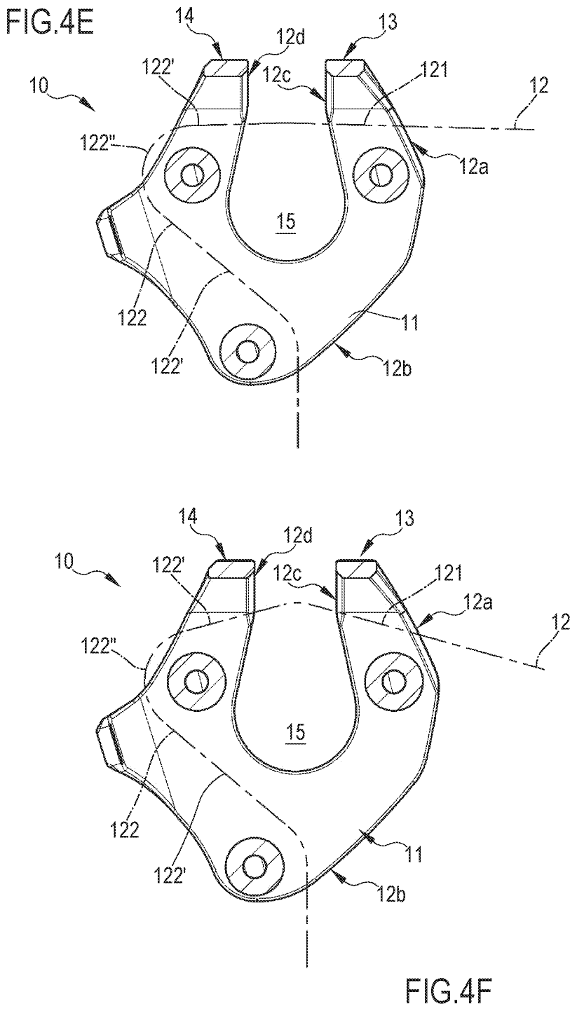

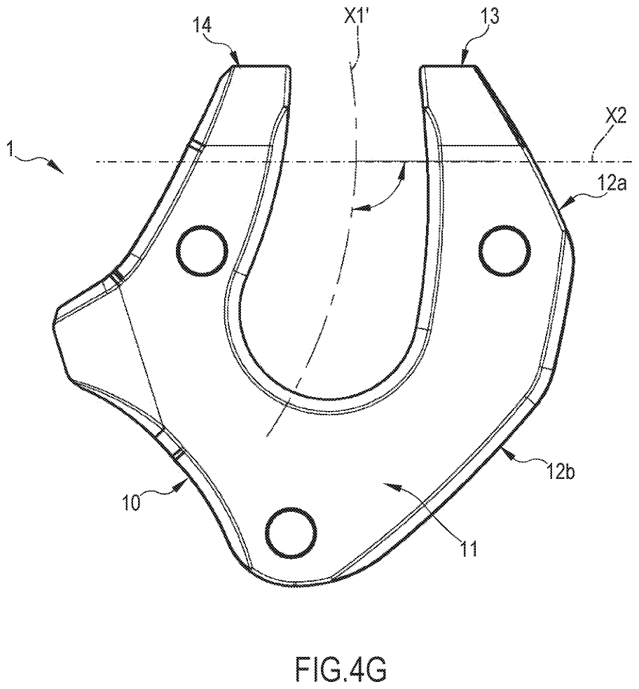

In FIGS. 4A-4D a further embodiment is depicted, wherein the body 11 consists of a deep-drawn and/or folded metal sheet maintained in shape by a plurality of pins or rivets 10c, specifically three pins or rivets 10c. Said embodiment is a hybrid solution between the embodiments of FIGS. 1A-1C and 2A-2C.

In the remainder of the present description, reference will be made primarily to the embodiment of FIGS. 4A-4D. However, where applicable, what stated in relation to FIGS. 4A-4D applies to the embodiments of FIGS. 1A-1C, 2A-2C and 3A-3C.

As depicted in the attached figures, the body 10 has a mainly two-dimensional or flat development, i.e. it extends mainly along two dimensions (and therefore in a development plane) while the third dimension, typically called thickness, is lower than the other two dimensions. With reference to FIGS. 4A-4D, the body 10 extends more in the plane of FIG. 4B than it does in the plane of FIG. 4C relating to the thickness.

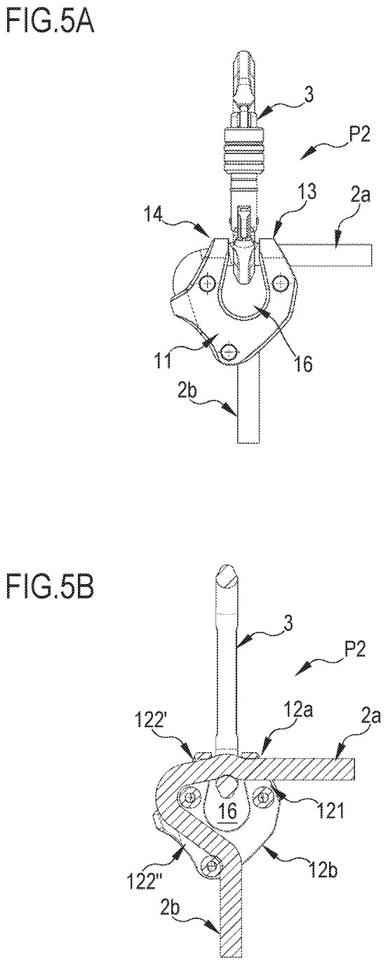

Regardless of the technique used for the implementation, as depicted e.g. in FIGS. 4E and 4F, the hollow body 10 is provided with a path 12 for the passage and sliding of a safety rope 2, also called safety cord (the path 12 is depicted schematically, e.g. in FIGS. 4E and 4F, by means of a dotted line which preferably identifies the centre-line of the path followed by the rope inserted into the device). In particular, the body 10 has a first seat 12a and a second seat 12b defined by holes or openings in the body 10, between which the path 12 extends inside said body 10. As depicted e.g. in FIG. 5B, said first seat 12a is configured to accommodate a free branch 2a of the safety rope 2. Similarly, said second seat 12b is configured to accommodate a loaded branch 2b of the safety rope 2.

In the present description, the term “loaded branch 2b” refers to the length of safety rope 2 adapted to be constrained to a load and therefore subject to a tensioning due to the weight force of the same load positioned at one end of rope 2 and which is intended to be secured to safety rope 2. The loaded branch 2b corresponds to a portion of rope 2 interposed between the load to be secured and an anchoring element/point, i.e. between the device 1 and the load to be secured, in the case in which the device 1 is connected to the anchoring element/point, or alternatively between the device 1 and the anchoring element/point, in the case in which the device 1 is connected to the load to be secured. The term “free branch 2a” means the remaining portion of rope extending from the device 1 to the other end of the safety rope 2, which is typically left free, i.e. not constrained to any object that causes it to be tensioned.

The body 10 comprises a main portion 11, a first portion 13 and a second portion 14 defining a concavity 15 between them. The body 10 of the device 1 has, as depicted by the front view of FIG. 4B, a concave shape defined by the first portion 13 and the second portion 14 together with the main portion 11. The first portion 13 and the second portion 14 are defined as two portions protruding or jutted from said main portion 11. In other words, said first portion 13 and second portion 14 are defined as two protuberances branching off from the main portion 11 of the body 10 so as to define the aforesaid concavity 15 between them. As shown, e.g., in FIGS. 1B, 2B, 3B and 4B, the concavity 15 is, therefore, defined as a loop or depression that “breaks the profile” of the body 10 of the device 1. By this expression, it is meant that the concavity 15 constitutes an abrupt discontinuity of the outer profile of the body 10.

According to an aspect of the present description, depicted in detail by way of example in FIGS. 4E and 4F (see the dotted line which, as stated, identifies the centre-line of the path of the rope inserted into the device), the path 12 defined inside the body 10 comprises a first length 121 and at least one second length 122. Said first length 121 extends in said first portion 13 and comprises said first seat 12a, i.e. said first portion 13 is at least partially hollow to define said first length 121 which extends from said first seat 12a. In particular, said first length 121 extends in said first portion 13 from said first seat 12a to a first opening 12c facing said concavity 15.

Said at least one second length 122 extends at least in said second portion 14 and comprises said second seat 12b. Preferably, such as e.g. depicted in FIGS. 4E and 4F, said at least one second length 122 extends from said second portion 14, where there is a second opening 12d facing said concavity 15, to said main portion 11, where the second seat 12b is arranged. Said at least one second length may consist of one or more second lengths, i.e. it may consist of a single continuous second length 122, as in the embodiments of FIGS. 1B, 2B and 3B, or multiple communicating second lengths 122, e.g. two separate but communicating second lengths, such as e.g. depicted in FIG. 4D.

According to another aspect of the present description, depicted e.g. in FIG. 5B, said concavity 15 is, in use, configured to be crossed by said safety rope 2, i.e. the safety rope 2 divides or cuts said concavity 15. Specifically, the body 10 defines, with said safety rope 2, a closed section 16 inside said concavity 15. This closed section 16 is configured, in use, to accommodate a connector 3, which is therefore crossed by said safety rope 2.

In the accompanying figures, the connector 3 is depicted, by way of non-limiting example, as a karabiner and, therefore, equipped with a movable portion intended to allow the opening/closing of the karabiner body.

It should be noted that according to possible embodiments (not shown in the accompanying figures), one or more further connectors can be constrained to the connector 3 inserted into the body 10 of the device 1. This at least one further connector, which is preferably connected to the anchoring point (e.g. on a wall) advantageously allows the device 1 to be oriented with respect to the anchoring point. In fact, the presence of a further connector (e.g. a further karabiner or a ring) connected to the connector 3 (e.g. a karabiner or a ring), which is inserted into the closed section of the body 10 of the device 1, allows e.g. to arrange the body 10 of the device 1 with its development plane in a substantially perpendicular or angled position with respect to the wall where the anchoring point is arranged. In the absence of the further connector, the connector 3, which is inserted into the closed section of the device 1, would determine the positioning of the body 10 of the device 1 with its own development plane arranged substantially parallel to the wall where the anchoring point is placed.

As depicted, e.g., in FIGS. 4B and 4D, according to a possible embodiment, said concavity 15 extends substantially along a first axis X1, i.e. has a substantially rectilinear development. Said first 13 and second 14 portions have a development axis substantially parallel to the first axis X1 of the concavity 15, i.e. they branch off from said main portion 11 parallel to the first axis X1. This way, the body 10 of the device 1 has a substantially “U2 shape in which the inner part of the “U” shape is depicted by the concavity (or concave portion) 15, such as e.g. depicted in the attached figures.

In alternative embodiments, the concavity 15 has shapes more articulated than the substantially rectilinear shape depicted in FIGS. 4A-4F. In particular, the concavity 15 may have a development line X1′ of said concavity 15, which comprises at least one curvilinear length or at least two rectilinear lengths angled to each other or a combination of at least one curvilinear length and at least one rectilinear length. In the embodiment of FIG. 4G, e.g., the development line X1′ comprises a curvilinear length. In these embodiments, as depicted again in FIG. 4G, the first portion 13 and the second portion 14 of the body 10 also have contours that reproduce such a development line or extend similarly to the same development line, so as to delimit such concavity 15.

Preferably, as can be noted in FIG. 4D, said first length 121 of the path extends, in said first portion 13, in one distal end thereof of the same first portion 13 with respect to the main portion 11 of the body 10. Similarly, said at least one second length 122 extends, at least as far as the branch involving the second portion 14 is concerned, in a distal end of the same second portion 14 with respect to the main portion 11 of the body 10.

According to a further aspect of the present description, such as e.g. depicted in FIG. 4E, the first length 121 of the path 12 is substantially rectilinear, i.e. said first length extends substantially in a straight line from said first seat 12a to said first opening 12c facing on the concavity 15. The at least one second length 122 comprises at least one rectilinear sector 122′ extending at said second portion 14, i.e. said at least one second length 122 comprises a rectilinear sector 122′ extending substantially in a straight line from said second opening 12d facing the concavity 15. The at least one second length 122 further comprises a curvilinear sector 122″ adapted to act as a junction between the rectilinear sector 122′ and the second seat 12b. Observing, e.g., the sectional view of FIG. 4E, the at least one second length 122 comprises, starting from said second opening 12c to said second seat 12b, a first rectilinear sector 122′ at said second portion 14, a second rectilinear sector 122′ extending in said main portion 11 and a curvilinear sector 122″ acting as a junction between the aforesaid rectilinear sectors.

As shown in the embodiment of FIG. 4D, said first length 121 extends along a second axis X2 and said rectilinear sector 122′ of said at least one second length 122 of the path 12 extends coaxially to said first length 121. In other words, said first length 121 and said rectilinear sector 122′ are substantially aligned, as depicted in the possible embodiment of FIG. 4E.

According to a further possible embodiment, e.g. depicted in FIG. 4F, said first length 121 and said rectilinear sector 122′ are angled to each other, they are arranged to form an angle with each other. Preferably, said angle is between 140° and 180°. Even more preferably, said angle is between 150° and 170°.

Specifically, said second axis X2 is not parallel to said first development axis X1 of said concavity 15. Preferably, said first axis X1 and second axis X2 form an angle with each other between 60° and 120°. Even more preferably, said first axis X1 and second axis X2 form an angle with each other between 75° and 105°. According to a possible embodiment, such as e.g. depicted in the embodiment of FIG. 4D, said first axis X1 and said second axis X2 are substantially perpendicular to each other. Consequently, the safety rope 2 crosses the concavity 15 by following the second axis X2, therefore perpendicular to the first axis X1 of the concavity 15, as can be appreciated e.g. in FIG. 5B. As can be appreciated e.g., in FIG. 4G, also in the embodiments in which the concavity 15 has a more complex development line X1′, it is however possible to measure the angle between said development line X1′ and said second axis X2 at their intersection point.

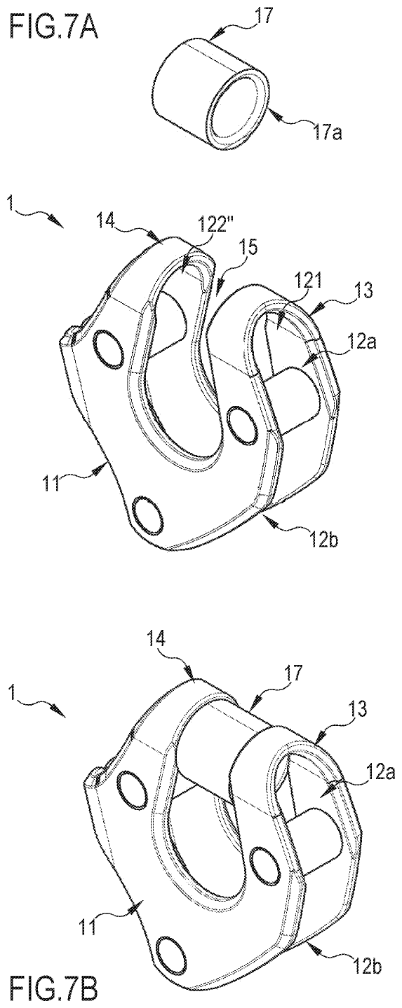

According to a further aspect, the device 1 preferably comprises a movable insert 17. Some embodiments in which the device 1 comprises the movable insert 17 are depicted in detail in FIGS. 7A-7B, 10A-10B and 13A-13E.

In particular, said movable insert 17 is configured to be movably housed inside said concavity 15 and to be interposed, in use, between said safety rope 2 and said connector 3. This position allows said movable insert 17 to cooperate with said connector 3 during the blocking or braking actions of the safety rope 2. In other words, said movable insert 17 avoids that there is a direct contact between the connector 3 and the safety rope 2 and acts on the safety rope 2 under the action of the connector 3. Specifically, according to an aspect of the invention, said movable insert 17 is configured to move inside said concavity 15 along the first axis X1 of development of the same concavity (or along the development line X1′, e.g. in the embodiment of FIG. 4G).

According to an aspect, said movable insert 17 comprises an at least partially tubular first element 17a. Said first element 17a has a housing configured, in use, to contact said safety rope 2. In other words, said housing is configured to accommodate and contact said safety rope 2.

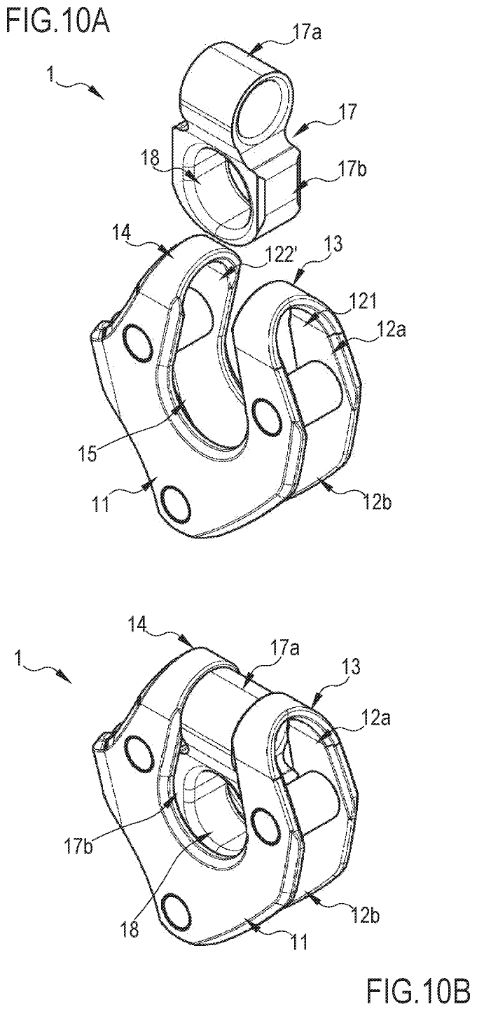

According to an embodiment depicted in FIGS. 7A-7B and 10A-10B, said first element 17a has a hollow tubular, specifically ring-like, shape in which the inner cavity constitute the aforesaid housing inside which the safety rope 2 is inserted in use.

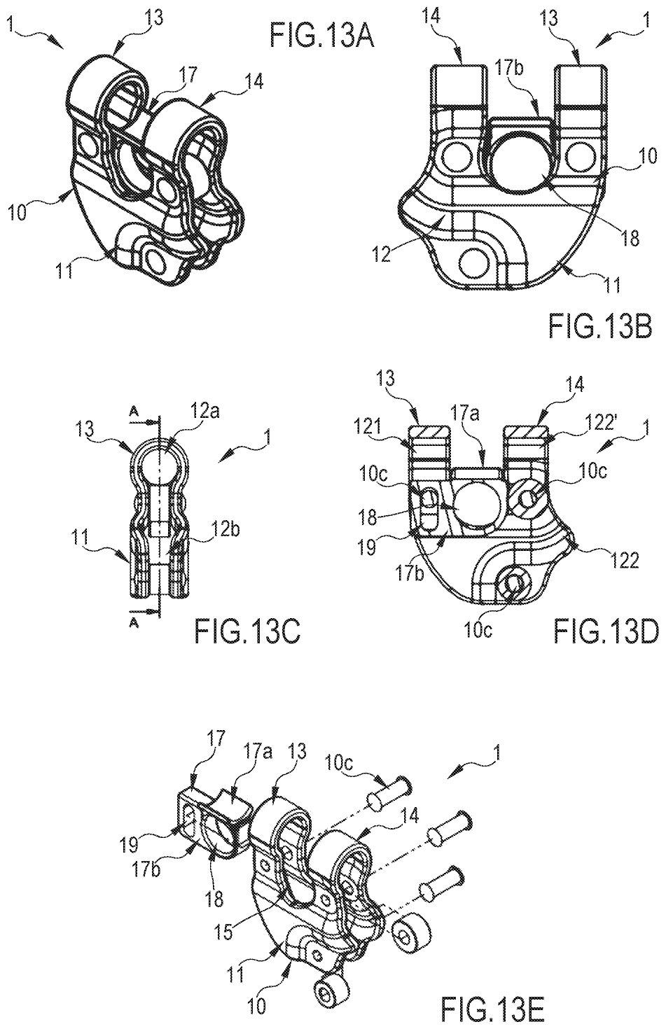

According to another embodiment depicted e.g. in FIGS. 13A-13E, said housing is a concave seat, e.g. partially tubular, which contacts the safety rope 2 housed therein.

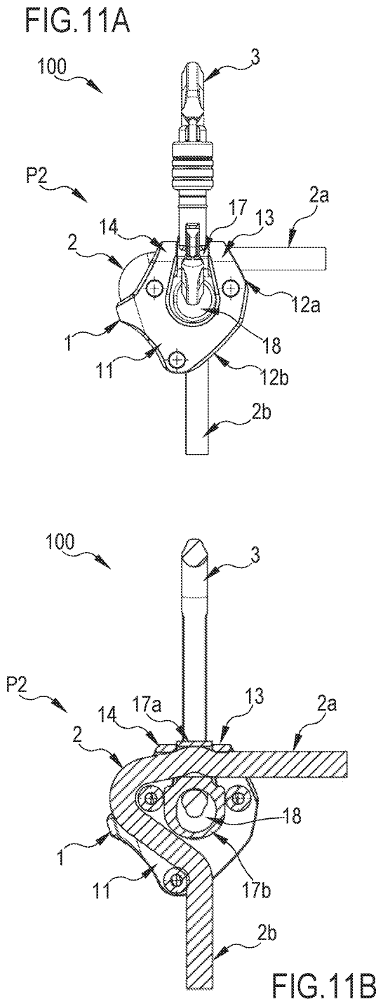

Preferably, such as e.g. depicted in FIGS. 10A-10B and 13A-13E, the movable insert 17 has a second element 17b. Said second element 17b is a flat element, i.e. with a mainly two-dimensional development and adapted, in use, to be arranged as a partial obstruction of said closed section 16. As depicted, said second element 17b is equipped with a through hole 18. Said hole 18 exposes at least one part of the closed section 16 and is configured, in use, to accommodate, i.e. to be crossed by said connector 3, as shown e.g. in FIGS. 11A-11B.

In an embodiment, e.g. depicted in FIGS. 13A-13E, said second element 17b comprises a slot 19. Said slot 19 is configured to allow the combination, preferably by means of a pin, of said movable insert 17 with said body 10. In the depicted embodiment, one of the rivets 10c acts as a pin to movably constrain said movable insert 17 to said body 10. Specifically, said slot 19 has a longitudinal development which restricts the movement of the movable insert 17 inside the concavity 15 of the body 10. In other words, the slot 19 acts as an end stop for the movement, typically along the first axis X1, of the movable insert 17 inside the concavity 15.

In some embodiments, it is provided that the body 11 of the device 1 has at least one holding element 20 of the rope 2 in the proximity of the length 122 of the path 12, so as to inhibit the accidental release of the rope 2 and thus creating slacks or potential entanglement points due to loops of free rope.

As described above, the device 1 is particularly adapted to cooperate with a safety rope 2 and a connector 3 to brake or block the sliding of the safety rope 2 inside the body 10 of the device 1. A blocking/braking/adjusting system 100 for the adjustment of a safety rope 2, comprising the device 1, will therefore now be described. This blocking/braking system for adjusting a safety rope 2 will be referred to hereinafter only as system 100 for the sake of simplicity.

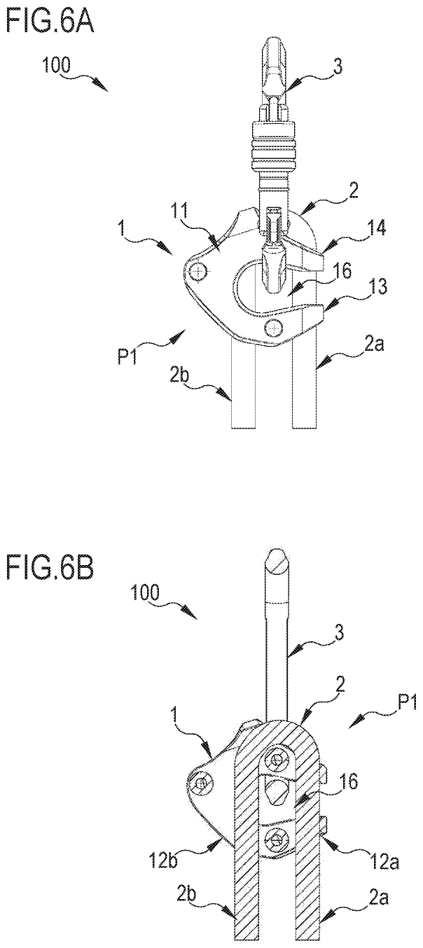

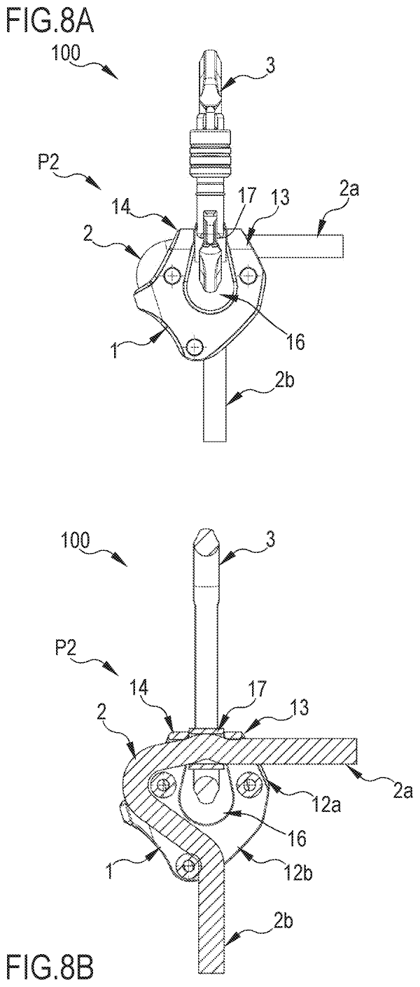

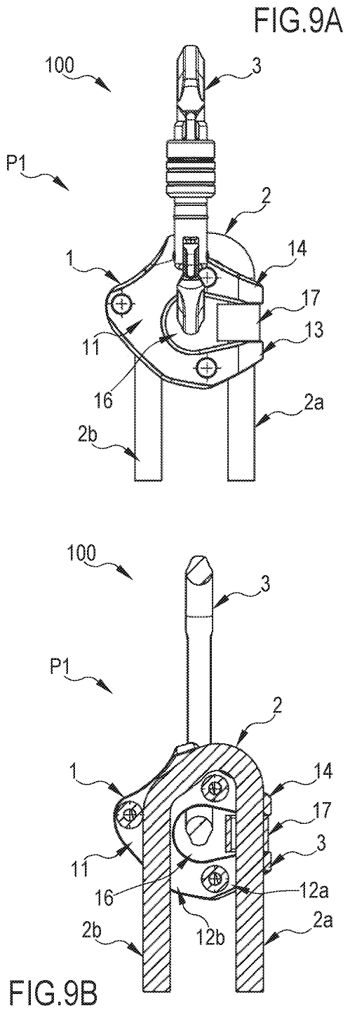

Different embodiments of the system 100 are depicted in the attached figures depending on the embodiment assumed by the device 1. For example, FIGS. 5A-5B and 6A-6B show the system 100 comprising the device 1 in the embodiment depicted in FIGS. 4A-4D. Similarly, FIGS. 8A-8B and 9A-9B show the system 100 comprising the device 1 in the embodiment depicted in FIGS. 7A-7B and FIGS. 11A-11B and 12A-12B show the system 100 comprising the device 1 in the embodiment depicted in FIGS. 10A-10B.

The system 100 further comprises the safety rope 2. Said safety rope 2 is configured to be inserted into said device 1 with the free branch 2a entering said first seat 12a of the path 12 defined in the body 10 of the aforesaid device 1 and with the loaded branch 2b exiting from said second seat 12b. In particular, as depicted e.g. in FIG. 5B, said safety rope 2, when travelling along the path 12, is configured to cross said concavity 15, thus defining with said body 10 of said device 1 a closed section 16.

Specifically, starting from said first seat 12a and arriving at the second seat 12b, the safety rope 2 travels along the first length 121 of the path 12, exits from the first opening 12c facing the concavity 15, enters the second opening 12d by de facto crossing the concavity 15 and defining the aforesaid closed section 16, before travelling along the at least one second length 122 of the path 12 until the second seat 12b is reached.

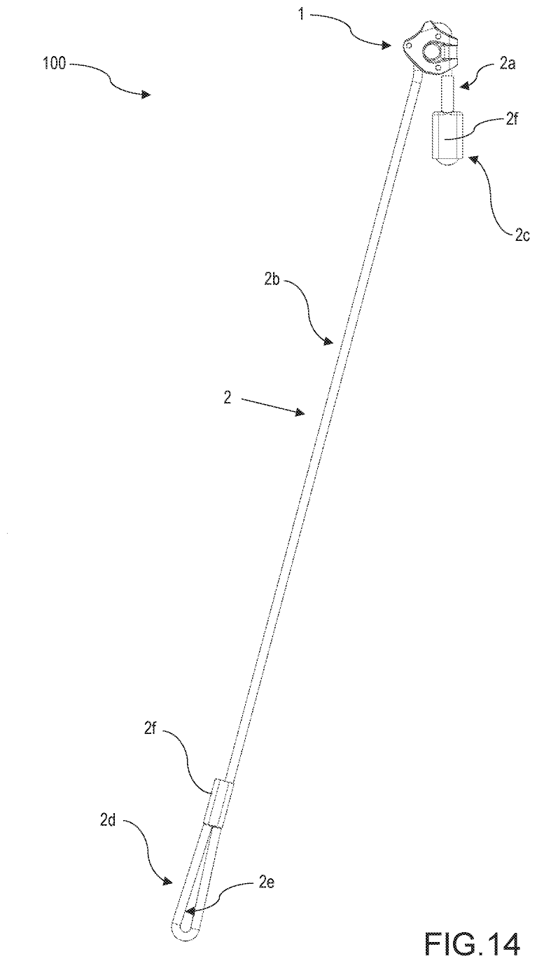

According to a possible embodiment, such as e.g. can be seen in FIG. 14, the safety rope 2 used in the device 1 and in the system 100 according to the present invention comprises at least one end portion 2c, 2d, preferably both end portions 2c, 2d folded over at least one length of the safety rope 2.

In other words, at least one or both of the end portions 2c and 2d of the rope 2 at the ends of the free branch 2a and of the loaded branch 2b are folded over at least one previous length of the rope so that they overlap.

Advantageously, the presence of end portions folded over at least one length of the rope allows to increase the section of the same rope substantially at the ends. In use, in the case where the rope 2 slides inside the body 10 of the device until the end portion reaches the contact with the body of the same device, the increased section portion due to the overlapping of the rope allows to produce a braking action due to the resistance generated by the friction that obstructs the sliding of the increased section of the rope with the body of the device.

Furthermore, the presence of at least one or both of the folded end portions 2c, 2d increases the resistance given by the rope and, therefore, the load and/or tension that can be handled by the rope 2 and the device 1 in which it is used.

It should be noted that the overlapping of the end portion may be such as to form a slot 2e, e.g. such as can be seen in FIG. 14 for the end 2d of the loaded branch 2b, or it may be such as to be completely overlapped without the formation of slots as for the end 2c of the free branch 2a, e.g. visible in FIG. 14.

In addition, the operation of folding the end portion may comprise cutting the rope by forming two half-sections that are both folded over the previous length of the rope, e.g. such as can be seen in FIG. 14 for the end portion 2c of the free branch 2a.

According to possible embodiments, the folded end portions 2c, 2d are constrained to a length of the safety rope preferably by sewing and/or by applying a heat-shrinking sheath or sleeve 2f.

Obviously, further ways of constraining the end portion 2c, 2d to the length of rope are not excluded.

This constraining operation of the end portion is performed after the insertion of the rope 2 inside the body 10 of the device.

It should be noted that although the embodiment of the device 1 equipped with the movable insert 17 has been shown in FIG. 14, the possible embodiment of the rope equipped with at least one, or both of the folded end portions 2c 2d applies to different embodiments of the device 1 and the system 100 according to the present invention. Furthermore, what is described herein with reference to the system applies generally to the rope 2 which can be used with the device 1 according to the invention and with reference to the method according to the invention.

As mentioned, the system 100 also comprises a connector 3. Said connector 3 is configured to be inserted into said closed section 16 and to be crossed by said safety rope 2. In use, therefore, the connector 3 has at least one part of its closed profile interposed between the body 10 of the device 1 and the safety rope 2, as clear e.g. from FIG. 5B.

According to an aspect, the system 100 is configured to be movable between a free-sliding position P1, as can be seen e.g. in FIG. 6B, and a blocking/braking position P2, as can be seen e.g. in FIG. 5B. In the free-sliding position P1, the safety rope 2 is free to slide inside the path 12 of said device 1, i.e. there is no prevailing frictional braking interaction between the safety rope 2 and connector 3. In this position, the connector 3 is typically in contact mainly with the body 10 of the device 1, generally acting in the direction of its second portion 14.

In the blocking/braking position P2, on the other hand, the sliding of the safety rope 2 in said path 12 is prevented or braked. Specifically, the sliding of the safety rope 2 is prevented by the action of the connector 3 which, directly or indirectly in case the movable insert 17 is present, pushes on said safety rope 2, which in turn presses on the body 10 and, due to the friction generated, cannot slide freely inside the aforesaid path 12. The action of the connector 3 may be such as to throttle the safety rope 2, thus totally blocking its movement (blocking condition), or only to slow its sliding due to the friction generated by the pressure on the walls of the body 10 of the device 1 (braking condition).

The switching between said free-sliding position P1 and said blocking/braking position P2 is determined by a relative rotation between the device 1 and the connector 3. Switching from the free-sliding position P1 to the blocking/braking position P2 corresponds to a relative rotation between device 1 and connector 3 in one direction. The opposite switching from the blocking/braking position P2 to the free-sliding position P1 is determined by a relative rotation between the device 1 and connector 3 in the opposite direction.

In the embodiment of FIGS. 5A-5B and 6A-6B, the system 100 is denoted by the device 1 of FIG. 4A, i.e. without the movable insert 17. In this embodiment, in the free-sliding position P1, the connector 3 contacts mainly the body 10 of the device 1, in particular at the second portion 14. When the system 100 is in said blocking/braking position P2 depicted in FIGS. 5A-5B, the connector 3 directly contacts the safety rope 2 which, under the action of the connector 3, in turn presses on the body 10 and is braked. In particular, in the blocking/braking position P2, the rope 2 presses on the walls of the first portion 13 and the second portion 14 at the first length 121 of the path 12 and at the at least one second length 122 of the path 12. It should be noted, therefore, that the safety rope 2 does not contact the body 10 at its portion interacting with the closed profile of the connector 3, but rather in the portions of the body 10 at the first portion 13 and the second portion 14. In the depicted embodiment, the switching from the free-sliding position P1 to the blocking/braking position P2 provides for a counter-clockwise rotation of the device 1 with respect to the connector 3 in the plane of FIGS. 5B and 6B. On the contrary, the switching from the blocking/braking position P2 to the free-sliding position P1 provides for a clockwise rotation of the device 1 with respect to the connector 3 in the plane of FIGS. 5B and 6B. It should be noted in FIG. 5B that, when the system is in the blocking/braking position P2, the connector 3 acts on the safety rope 2 by pushing it against the walls of the first portion 13 and the second portion 14, braking it by friction or throttling it.

In the embodiment of FIGS. 8A-8B and 9A-9B the system 100 is depicted with the device 1 of FIG. 7A-7B, i.e. equipped with the movable insert 17 consisting only of the hollow or annular tubular-shaped first element 17a. Unlike the embodiment previously described in relation to FIGS. 5A-5B and 6A-6B, when the system is in the blocking/braking position P2, in this embodiment the connector 3 does not contact the safety rope 2 directly but acts on the latter indirectly by means of the movable insert 17. In other words, the connector 3 transfers its motion to the safety rope 2 by means of the movable insert 17.

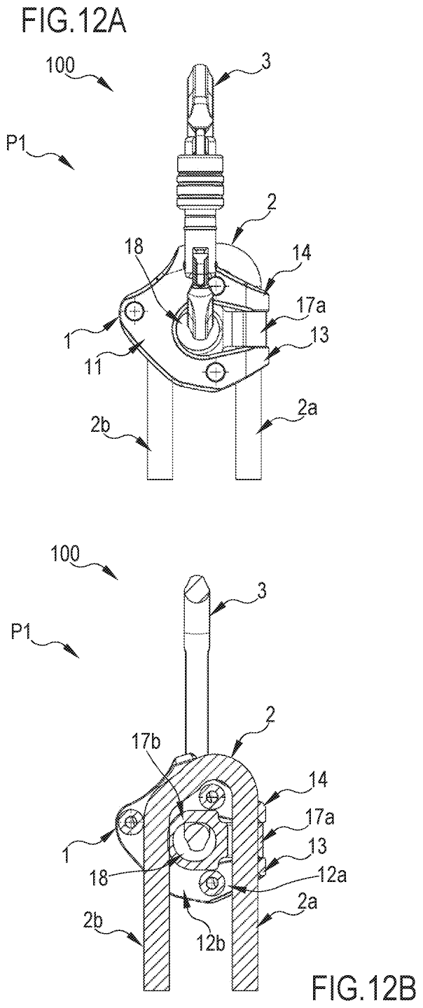

In the embodiment of FIGS. 11A-11B and 12A-12B the system 100 with the device 1 of FIG. 10A-10b is depicted, i.e. equipped with the movable insert 17 consisting of both the hollow or annular tubular-shaped first element 17a and the second element 17b equipped with a hole 18. In this embodiment, the connector 3 is inserted inside the hole 18 and, therefore, during the rotation between the positions P1-P2 and vice versa, the connector 3 continuously and mainly contacts the movable insert 17 through the hole 18 of the second element 17b.

Still another object of the present description is a method for adjusting the safety rope 2 and positioning a load by using the device 1 previously depicted. This method corresponds to the modes of pre-arranging the system 100 and using the device 1, in the context of said system 100, to block, brake and/or adjust the sliding of the safety rope 2, to which a load is firmly combined.

According to a first aspect, the method for adjusting the safety rope 2 and positioning a load comprises a step of inserting the safety rope 2 into the device 1. As mentioned, the step of inserting the rope into the device body is not necessarily carried out by the end user but can be carried out by the manufacturer which then provides the user with the device already equipped with the safety rope inserted.

It should also be noted that the step of inserting the rope into the body of the device may be followed by the step of folding one or both of the end portions 2c, 2d onto at least one length of the safety rope and preferably of constraining the folded portion onto this length of the rope, e.g. by sewing and/or by applying a heat-shrinking sheath or sleeve.

With reference, for example, to the embodiment of FIG. 5B, the step of inserting the rope provides that the safety rope 2 is inserted into said first seat 12a of the path 12, passed subsequently through said first length 121 and through said at least one second length 122 and then exited from said second seat 12b. The safety rope 2 has the free branch 2a entering said first seat 12a and the loaded branch 2b exiting from said second seat 12b. In particular, passing from said first length 121 to said at least one second length 122, more specifically to the rectilinear sector 122′ at the second portion 14, the safety rope 2 creates the closed section 16 with the body 10 of the device 1 by crossing the first opening 12c and the second opening 12d facing the concavity 15.

The method for adjusting the safety rope 2 and positioning a load comprises, subsequently, a step of inserting said connector 3 into said closed section 16. As described above, said connector 3 is configured to be crossed by the safety rope 2, i.e. the safety rope 2 cannot be pull out of said connector other than by slipping it out or opening the closed profile of the same connector 3, e.g. by opening the hook in the case of the connector 3 being a karabiner. It should be noted that the combined effect of the steps of inserting the safety rope 2 and inserting the connector 3 corresponds to the arrangement of the system 100 previously set forth.

The method for adjusting the safety rope 2 and positioning a load further comprises a step of securing a load to said safety rope 2 or to the body of the device, in the event that the device is not constrained to an anchoring point through the connector 3 but it is the load that is constrained to the device 1 through the connector 3.

The possible embodiment in which the load is constrained to the safety rope will be described below (the description is also valid for the embodiments in which the load is constrained to the device, with the difference that the connector 3 will not be constrained to an anchoring point, but it is the load that will be connected to the body of the device, e.g. by means of the connector 3).

The step of securing a load to said safety rope 2 requires the safety rope 2 and the load to be firmly combined in a known manner, so that the detachment between said safety rope 2 and said load is highly unlikely or almost impossible. It is also emphasised that the load can be a person, e.g. a climber, or an object, e.g. a body which is intended to be positioned, by adjusting it at a certain length of loaded rope. It should also be noted that said step of securing the load can be carried out prior to the step of inserting the connector 3 or the step of inserting the safety rope 2 into the device 1, without compromising the execution of the entire method.

Subsequently, the method for adjusting the safety rope 2 and positioning a load comprises a step of adjusting the length of said rope 2 in order to position said load, i.e. to position the load by a suitable adjustment of the length of the loaded branch 2b. This step provides for modifying the reciprocal position between said device 1 and said connector 3, typically by rotating the device 1. Specifically, the relative position between said device 1 and said connector 3 may be any position between the free-sliding position P1, in which the safety rope 2 is free to slide inside the path 12, and the blocking/braking position P2, in which a sliding of the safety rope along said path is prevented or braked.

When said loaded branch 2b is subjected to tension, typically due to the weight of the secured load, the system 100 moves to the blocking/braking position P2. In this blocking/braking position P2, the connector 3 directly or indirectly acts on the safety rope 2, depending on the embodiment of the device 1, so as to push it against the walls of the body 10 at the first length 121 and the rectilinear sector 122′, i.e. the safety rope 2 contacts the walls of the first portion 13 and the second portion 14. Depending on the force and the direction the connector imparts on the safety rope 2, the effect may be simply braking, due to the dynamical friction that is created in the contact between the safety rope 2 and the walls of the first and second portions of the body 10, or even blocked, as said connector 3 throttles the safety rope 2 in its portion crossing the concavity 15, as depicted in FIGS. 5B, 8B and 11B.

Said loaded branch 2b may also not be subjected to tension, e.g. because the secured load unloads its weight force on a support or rest, so that the tensioning on the loaded branch 2b given by the secured load is reduced, eliminated or overcome. As stated, the system 100 can be brought to the free-floating position P1, in which the connector 3 does not act mainly on the safety rope 2 but rather its action is directed towards the body 10, so that no braking action occurs on the rope 2. The movement from the blocking/braking position P2 to the free-sliding position P1 is generally caused by the manual action of an operator, who rotates the device 1 with respect to the connector 3 by optionally using a lever not depicted in the enclosed figures and with which the device 1 may be equipped, to facilitate the manoeuvre.

Advantageously, the operator can also act by stressing the free branch 2A of the rope by traction while manually rotating the device 1. Furthermore, by manually acting on the device 1, an operator can generate a controlled sliding of the safety rope 2. Specifically, an operator can only partially rotate the device 1 without making it assume the free-sliding position P1 with respect to the connector 3. In this condition, the rope 2 is not throttled against the walls of the body 10 and allows a controlled, i.e. braked but not blocked, movement of the secured load.

In some embodiments, e.g. that in which blocking/braking devices depicted in FIGS. 8A to 13E are used, the method for adjusting the safety rope 2 and positioning a load comprises, prior to the step of inserting said safety rope, a step of movably housing said movable insert 17 inside said concavity 15.

In the embodiments in which the device 1 comprises a movable insert 17 equipped with a second element 17b with a hole 18 as depicted in FIG. 10A-B, the step of inserting said connector 3 provides for inserting said connector 3 through said hole 18.

1. Blocking/braking device (1) for adjusting a safety rope (2), comprising:
an at least partially hollow body (10) provided with a path (12) for said safety rope (2) to pass inside said body (10) between a first seat (12a), adapted to accommodate a free branch (2a) of said safety rope (2), and a second seat (12b), adapted to accommodate a loaded branch (2b) of said safety rope (2);
said body (10) comprising a main portion (11), a first portion (13) and a second portion (14) defining between them a concavity (15) and said path (12) comprising a first length (121) extending in said first portion (13) and comprising said first seat (12a), and at least one second length (122) extending at least in said second portion (14) and comprising said second seat (12b); and
said concavity (15) configured to be crossed by said safety rope (2) when in use, said body (10) defining a closed section (16) with said safety rope (2) inside said concavity (15).

2. The device (1) according to claim 1, wherein said concavity (15) extends substantially along a first axis (X1) and said first portion (13) and second portion (14) have a development axis substantially parallel to the first axis (X1).

3. The device according to claim 2, wherein said first portion (13) and said second portion (14) branch off from said main portion (11) substantially parallel to the first axis (X1) of the concavity (15).

4. The device according to claim 1, wherein the body (10) of the device has a substantially U shape in one section thereof along a plane along said development axis (X1).

5. The device (1) according to claim 1, wherein said first length (121) of the path (12) is substantially rectilinear and wherein said at least one second length (122) comprises at least one rectilinear sector (122′) extending at said second portion (14).

6. The device (1) according to claim 5, wherein said first length (121) of said path (12) extends along a second axis (X2), said first length (121) and said rectilinear sector (122′) of said at least one second length (122) of the path (12) being coaxial or angled to each other to form an angle between 140° and 180°.

7. The device (1) according to claim 6, wherein said second axis (X2) of development of said first length (121) of the path (12) and said first axis (X1) form an angle with each other between 60° and 120°.

8. The device (1) according to claim 1, further comprising a movable insert (17), said movable insert (17) being configured to be movably housed inside said concavity (15) and to be interposed between said safety rope (2) and a connector (3) when in use.

9. The device (1) according to claim 8, wherein said movable insert (17) comprises an at least partially tubular first element (17a), said first element (17a) having a housing configured to accommodate said safety rope (2) when in use.

10. The device (1) according to claim 9, wherein the movable insert (17) further comprises a second flat element (17b) adapted to be arranged to partially obstruct said closed section (16) when in use, said second element (17b) being equipped with a hole (18).

11. The device (1) according to claim 10, wherein said second flat element (17b) comprises a slot (19) for joining said movable insert (17) to said body (10).

12. The device according to claim 1, wherein said first portion (13) and said second portion (14) each protrude from the main portion (11) forming two protuberances branching off from the main portion (11) of the body (10) of the device so as to define said concavity (15) therebetween.

13. The device according to claim 1, wherein said concavity (15) is defined as a depression in a profile of the body (10) of the device.

14. The device according to claim 1, wherein said first length (121) extends in said first portion (13) from said first seat (12a) to a first opening (12c) which faces said concavity (15).

15. The device according to claim 1, wherein said at least one second length (122) extends from said second portion (14), where there is a second opening (12d) facing said concavity (15), to said main portion (11) where said second seat (12b) is arranged.

16. Blocking/braking system (100) for adjusting a safety rope (2), comprising:
a blocking/braking device (1) for adjusting a safety rope (2), comprising:
an at least partially hollow body (10) provided with a path (12) for said safety rope (2) to pass inside said body (10) between a first seat (12a), adapted to accommodate a free branch (2a) of said safety rope (2), and a second seat (12b), adapted to accommodate a loaded branch (2b) of said safety rope (2);
said body (10) comprising a main portion (11), a first portion (13) and a second portion (14) defining between them a concavity (15) and in that said path (12) comprising a first length (121) extending in said first portion (13) and comprising said first seat (12a), and at least one second length (122) extending at least in said second portion (14) and comprising said second seat (12b); and
said concavity (15) configured to be crossed by said safety rope (2) when in use, said body (10) defining a closed section (16) with said safety rope (2) inside said concavity (15);
said safety rope (2) being configured to be inserted into said device (1) with the free branch (2a) entering said first seat (12a) and with the loaded branch (2b) exiting from said second seat (12b), said safety rope (2) defining a closed section (16) with said body (10) of the blocking/braking device (1);
a connector (3) configured to be inserted into said closed section (16) and to be crossed by said safety rope (2);
said system blocking/braking (100) being configured to be movable between a free sliding position (P1), in which the safety rope (2) is free to slide inside the path (12) of said device (1), and a blocking/braking position (P2), in which a sliding of the safety rope (2) along said path (12) is prevented or braked;
the switching between said free sliding position (P1) and said blocking/braking position (P2) being determined by a relative rotation between the device (1) and the connector (3).

17. The blocking/braking system (100) according to claim 16, wherein the connector (3) is in contact with the body (10) of the device (1) when the system (100) is in said free sliding position (P1) and wherein the connector (3) contacts said safety rope (2) when the system (100) is in said blocking/breaking position (P2).

18. The blocking/braking system (100) according to claim 16 further comprising a movable insert (17), said movable insert (17) being configured to be movably housed inside said concavity (15) and to be interposed between said safety rope (2) and said connector (3) when in use, wherein the connector (3) acts indirectly, by contacting said movable insert (17), on said safety rope (2) when the system (100) is in the blocking/braking position (P2).

19. The blocking/braking system (100) according to claim 18, wherein the movable insert (17) comprises a second flat element (17b) adapted to be arranged to partially obstruct said closed section (16), said second element (17b) being equipped with a hole (18) when in use, wherein said connector (3) passes through said hole (18).

20. The blocking/braking system (100) according to claim 16, wherein said safety rope (2) comprises at least one end portion (2c, 2d) folded over at least one length of the safety rope (2).

21. The blocking/braking system (100) according to claim 20, wherein at least one said folded end portion (2c, 2d) is constrained to a length of the safety rope by sewing and/or by applying a heat-shrinking sheath or sleeve (2f).

22. Method for adjusting a safety rope (2) by using the device (1) according to claims claim 1 said method comprising the steps of:
inserting said safety rope (2) into said device (1), said safety rope (2) being inserted into said first seat (12a), passing through said first length (121) and through said at least one second length (122) and exiting from said second seat (12b), said safety rope (2) defining, by passing from said first length (121) to said at least one second length (122), a closed section (16) with said body (10), said safety rope (2) having the free branch (2a) entering said first seat (12a) and the loaded branch (2b) exiting from said second seat (12b);
inserting a connector (3) into said closed section (16), said connector (3) being crossed by said safety rope (2);
securing a load to said loaded branch (2b) or to said device (1); and
adjusting a length of said rope (2) to position said load by modifying a relative position between said device (1) and said connector (3) between a free sliding position (P1), in which the safety rope (2) is free to slide inside the path (12) of said device (1), and a blocking/braking position (P2), in which a sliding of the safety rope (2) along said path (12) is prevented or braked.

23. The method according to claim 22, further comprising, prior to said inserting said safety rope (2), movably housing a movable insert (17) inside said concavity (15).

24. The device (1) according to claim 1, wherein said concavity (15) extends substantially along a development line (X1′) which comprises at least one curvilinear length, or at least two rectilinear lengths angled to each other, or a combination of at least one curvilinear length and at least one rectilinear length.
